(19) United States
(12) Patent Application Publication
(10) Pub. No.: US 2010/0166192 A1
(43) Pub. Date: Jul. 1, 2010

(54) INTEGRATED CIRCUIT FOR REDUCING RADIO FREQUENCY INTERFERENCE DUE TO ANTENNA EFFECTS

(76) Inventors: Li-Ying CHANG, Taipei County (TW); Ming-Chung Li, Taipei City (TW)

Correspondence Address: Muncy, Geissler, Olds & Lowe, PLLC, 4000 Legato Road, Suite 310, FAIRFAX, VA, 22033, US

(21) Appl. No.: 12/651,127

(22) Filed: Dec. 31, 2009

(30) Foreign Application Priority Data
Dec. 31, 2008 (TW) 097223950

(51) Int. Cl. H04H 20/47; H04B 15/00

(52) U.S. Cl. 381/2; 455/63.1

(57) ABSTRACT

The invention provides an integrated circuit for reducing radio frequency interference due to antenna effects. In one embodiment, the integrated circuit includes a pre-stage audio processor and a post-stage power amplifier. The pre-stage audio processor receives a left channel input signal and a right channel input signal, processes the left channel input signal to obtain a positive left channel signal and a negative left channel signal, and processes the right channel input signal to obtain a positive right channel signal and a negative right channel signal. The post-stage power amplifier amplifies the positive left channel signal and the negative left channel signal to obtain a left channel output signal, and amplifies the positive right channel signal and the negative right channel signal to obtain a right channel output signal.

### CROSS REFERENCE TO RELATED APPLICATIONS

This Application claims priority of Taiwan Patent Application No. 097223950, filed on Dec. 31, 2008, the entirety of which is incorporated by reference herein.

### BACKGROUND OF THE INVENTION

1. Field of the Invention

The invention relates to signal processing circuits, and more particularly to elimination of radio frequency interference of signal processing circuits.

2. Description of the Related Art

When an audio processing circuit processes an audio signal, the audio signal often contains noises caused by radio frequency interference. For example, when a cell phone is located in an area where there is strong electromagnetic waves, noises are induced by the electromagnetic waves in the audio signals, which degrade quality of audio signals being received by the cell phone. Of the communications systems, radio frequency interference for GSM communications systems are among the most problematic. A GSM communications system transmits signals with a modulation frequency of 217 Hz which falls in an audible frequency range of 20 Hz˜20 kHz (human hearing). Often, the GSM communications system will cause audio processing circuits located in the neighborhood of the GSM communications system to suffer from severe radio frequency interference.

Radio frequency interferences in audio processing circuits are caused mainly by antenna effect. Specifically, when a length of a metal line is equal to a quarter of a wavelength of a radio frequency signal, the metal line is inclined to receive the radio frequency signal, resulting in radio frequency interferences and noises. Referring to FIG. 1, a circuit diagram of conventional audio processing system 100 is shown. The audio processing system 100 comprises a pre-stage audio processor 102, a post-stage power amplifier 104, and an application circuit 106. The pre-stage audio processor 102 and the post-stage power amplifier 104 are respectively fabricated on independent integrated circuit chips which respectively have independent voltage sources VCC and VDD and ground voltages GND1 and GND2. In addition, the audio processing system 100 further comprises metal lines 111˜116 and 121˜126. Any of the metal lines 111˜116 and 121˜126 may receive radio frequency interferences due to antenna effects, resulting in noises sent to the application circuit 106, which degrade sound quality of audio signals of the audio processing system 100.

A conventional method for reducing radio frequency interferences is to cover the audio processing system 100 in a metal shell. The metal shell has a shielding effect shielding the audio processing system 100 from radio frequency interferences. The metal shell, however, increases manufacturing costs of the audio processing system 100, and increases the size of the audio processing system 100. When the size of the audio processing system 100 is large, the audio processing system 100 cannot be installed on portable electronic devices. Another conventional method for reducing radio frequency interferences is to increase the lengths of the metal lines 111˜116 and 121˜126. However, when the lengths of the metal lines 111˜116 and 121˜126 are increased, the size of the audio processing system 100 is also increased, increasing the circuit layout complexity of the audio processing system 100 on a print circuit board (PCB). A new method for reducing radio frequency interferences is therefore required.

### SUMMARY OF THE INVENTION

The invention provides an integrated circuit for reducing radio frequency interferences due to antenna effects. In one embodiment, the integrated circuit comprises a pre-stage audio processor and a post-stage power amplifier. The pre-stage audio processor receives a left channel input signal and a right channel input signal, processes the left channel input signal to obtain a positive left channel signal and a negative left channel signal, and processes the right channel input signal to obtain a positive right channel signal and a negative right channel signal. The post-stage power amplifier amplifies the positive left channel signal and the negative left channel signal to obtain a left channel output signal, and amplifies the positive right channel signal and the negative right channel signal to obtain a right channel output signal.

The invention also provides an integrated circuit for reducing radio frequency interference due to antenna effects. In one embodiment, the integrated circuit comprises a substrate, a pre-stage audio processor, a post-stage power amplifier, and a body terminal. The pre-stage audio processor is located on the substrate, receives an input signal, and performs a first signal processing procedure on the input signal to obtain a positive signal and a negative signal. The post-stage power amplifier is located on the substrate, and performs a second signal processing procedure on the positive signal and the negative signal to obtain an output signal. The body terminal is located on the substrate and couples ground contacts of the pre-stage audio processor and the post-stage power amplifier to a ground voltage.

A detailed description is given in the following embodiments with reference to the accompanying drawings.

### DESCRIPTION OF THE DRAWINGS

The invention can be more fully understood by reading the subsequent detailed description and examples with references made to the accompanying drawings, wherein:

FIG. 1 is a circuit diagram of conventional audio processing system;

FIG. 2 is a block diagram of an audio processing system according to the invention;

FIG. 3 is a block diagram of a pre-stage audio processor according to the invention;

FIG. 4 is a block diagram of a post-stage power amplifier according to the invention;

FIG. 5 is a cross-sectional view of an integrated circuit according to the invention;

FIG. 6A is a schematic diagram of an embodiment of a post-stage power amplifier eliminating a common mode noise according to the invention; and

FIG. 6B is a schematic diagram of another embodiment of a post-stage power amplifier eliminating a common mode noise according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

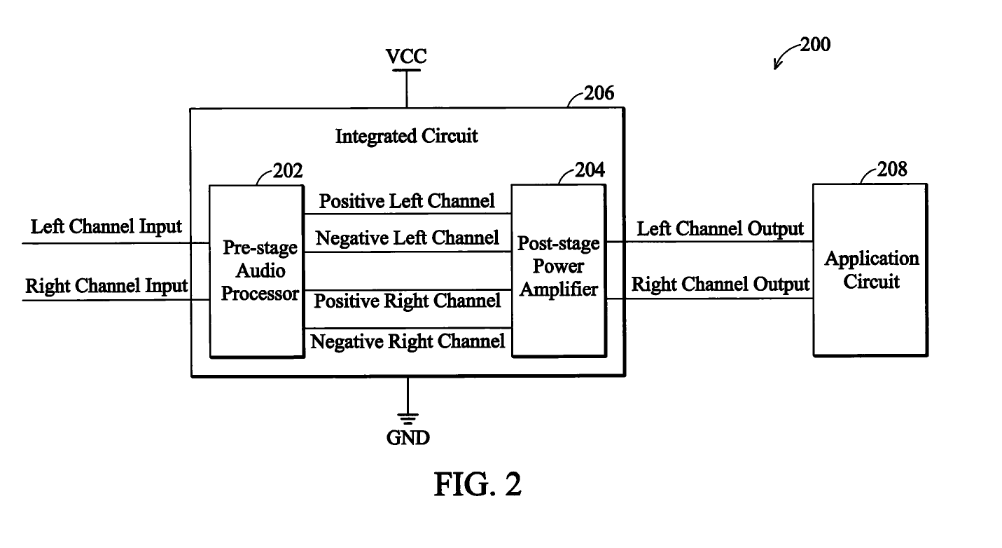

Referring to FIG. 2, a block diagram of an audio processing system 200 according to the invention is shown. The audio processing system 200 comprises an integrated circuit 206 and an application circuit 208. The integrated circuit 206 receives a left channel input signal and a right channel input signal. The integrated circuit 206 processes the left channel input signal to generate a left channel output signal, and processes the right channel input signal to generate a right channel output signal. In one embodiment, the integrated circuit 206 comprises a pre-stage audio processor 202 and a post-stage power amplifier 204. The pre-stage audio processor 202 and the post-stage power amplifier 204 are integrated into a chip 206. The metal lines connected to the pre-stage audio processor 202 and the post-stage power amplifier 204 are therefore encapsulated into the integrated circuit 206 to reduce the lengths of the metal lines, thus avoiding antenna effects. Audio signals transmitted on metal lines of the pre-stage audio processor 202 and the post-stage power amplifier 204 are therefore prevented from radio frequency interferences. In addition, when the metal lines of the pre-stage audio processor 202 and the post-stage power amplifier 204 are encapsulated into the integrated circuit 206, the area occupied by the pre-stage audio processor 202 and the post-stage power amplifier 204 is therefore reduced, thus reducing manufacturing costs.

The pre-stage audio processor 202 receives the left channel input signal and the right channel input signal. After the left channel input signal is received, the pre-stage audio processor 202 performs audio processing on the left channel input signal to obtain a positive left channel signal and a negative left channel signal. Similarly, after the right channel input signal is received, the pre-stage audio processor 202 performs audio processing on the right channel input signal to obtain a positive right channel signal and a negative right channel signal. The post-stage power amplifier 204 then receives the positive left channel signal, the negative left channel signal, the positive right channel signal, and the negative right channel signal. The post-stage power amplifier 204 then mixes the negative left channel signal with the positive left channel signal to obtain a left channel difference signal, and amplifies the left channel difference signal to obtain the left channel output signal. Similarly, the post-stage power amplifier 204 mixes the negative right channel signal with the positive right channel signal to obtain a right channel difference signal, and amplifies the right channel difference signal to obtain the right channel output signal.

Because the pre-stage audio processor 202 and the post-stage power amplifier 204 are located on the same substrate of the integrated circuit 206, and the pre-stage audio processor 202 and the post-stage power amplifier 204 are coupled to the same ground voltage, signals of the pre-stage audio processor 202 and the post-stage power amplifier 204 carry the same common mode noise. Thus, when the pre-stage audio processor 202 generates the positive left channel signal and the negative left channel signal is carrying a common mode noise due to radio frequency interferences, the post-stage power amplifier 204 mixes the negative left channel signal with the positive left channel signal to eliminate the common mode noise from the left channel difference signal, thus producing the left channel output signal without radio frequency interferences.

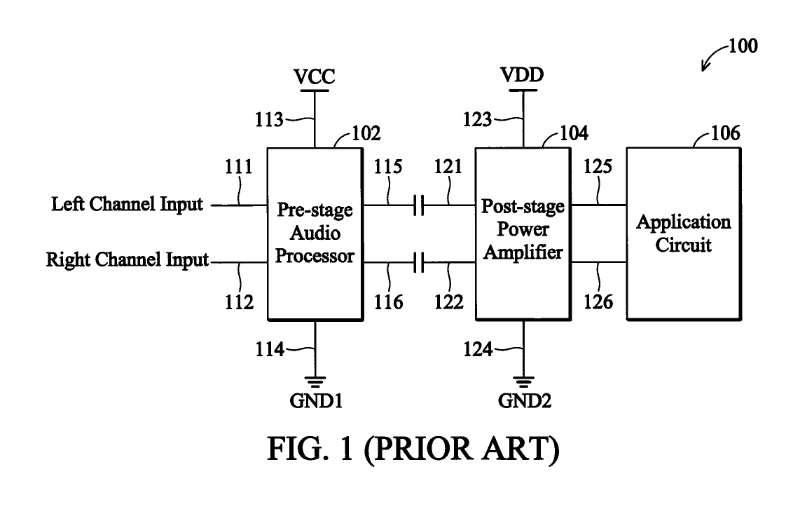

Similarly, when the pre-stage audio processor 202 generates the positive right channel signal and the negative right channel signal is carrying a common mode noise due to radio frequency interferences, the post-stage power amplifier 204 mixes the negative right channel signal with the positive right channel signal to eliminate the common mode noise from the right channel difference signal, thus producing the right channel output signal without radio frequency interferences. The integrated circuit 206 provided by the invention is therefore prevented from radio frequency interferences without drastically increasing manufacturing costs, and has improved performance when compared to the conventional audio processing system 100 shown in FIG. 1.

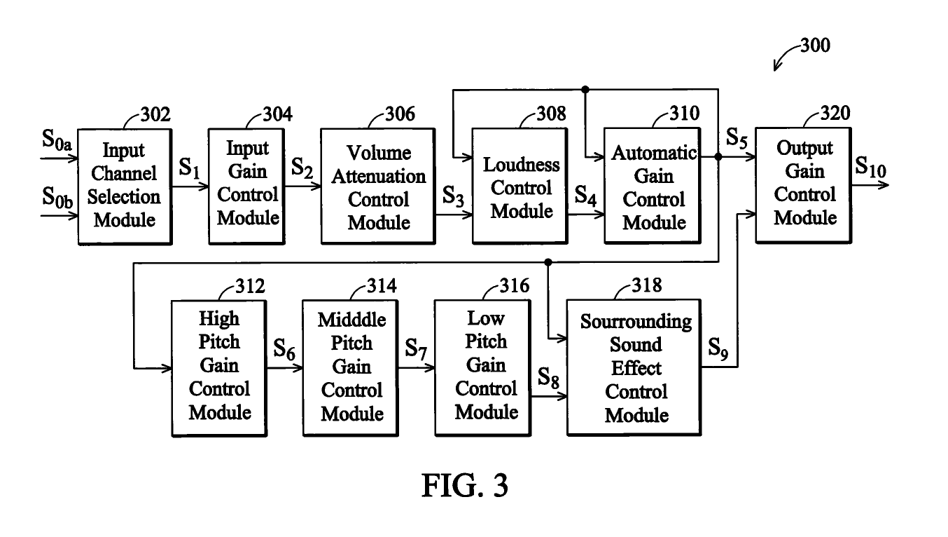

Referring to FIG. 3, a block diagram of a pre-stage audio processor 300 according to the invention is shown. In one embodiment, the pre-stage audio processor 300 comprises an input channel selection module 302, an input gain control module 304, a volume attenuation control module 306, a loudness control module 308, an automatic gain control module 301, and an output gain control module 310. The input channel selection module 302 first selects a signal S₁ from the left channel input signal S₀ₐ and the right channel input signal S_{0b}. The input gain control module 304 then adjusts a gain of the signal S₁ to obtain a signal S₂. The volume attenuation module 306 then attenuates a volume of the signal S₂ to obtain a signal S₃. The loudness control module 308 then adjusts a loudness of the signal S₃ to obtain a signal S₄. The automatic gain control module 310 then automatically adjusts a gain of the signal S₄ to obtain a signal S₅. The output gain control module 320 then derives a signal S₁₀ from the signal S₅ and a signal S₉ as an output of the pre-stage audio processor 300.

In one embodiment, the pre-stage audio processor 300 further comprises a high pitch gain control module 312, a middle pitch gain control module 314, a low pitch gain control module 316, and a surrounding sound effect control module 318. The high pitch attenuation control module 312 first adjusts an attenuation factor of a high-pitch component of the signal S₅ to obtain a signal S₆. The middle pitch attenuation control module 314 then adjusts an attenuation factor of a middle-pitch component of the signal S₆ to obtain a signal S₇. The low pitch attenuation control module 316 then adjusts an attenuation factor of a low-pitch component of the signal S₇ to obtain a signal S₈. The surrounding sound effect control module 318 then adjusts a surrounding sound effect of the signal S₈ to obtain the signal S₉. The output gain control module 320 then derives a signal S₁₀ from the signal S₅ and the signal S₉. When the signal S₁ is the left channel input signal S₀ₐ, the positive left channel signal and the negative left channel signal are derived from the signal S₁₀ as an output of the pre-stage audio processor 300. When the signal S₁ is the right channel input signal S_{0b}, the positive right channel signal and the negative right channel signal are derived from the signal S₁₀ as an output of the pre-stage audio processor 300.

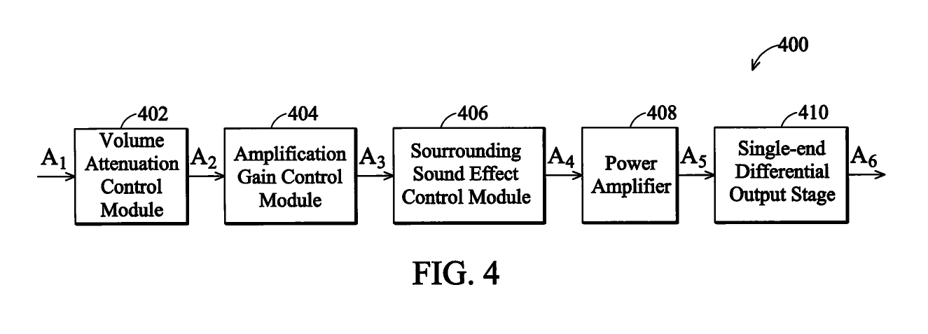

Referring to FIG. 4, a block diagram of a post-stage power amplifier 400 according to the invention is shown. In one embodiment, the post-stage power amplifier 400 comprises a volume attenuation control module 402, an amplification gain control module 404, a surrounding sound effect control module 406, a power amplifier 408, and an output stage 410. First, the volume attenuation control module 402 attenuates a volume of a signal Aₗ to obtain a signal A₂. The amplification gain control module 404 then adjusts an amplification gain of the signal A₂ to obtain a signal A₃. The surrounding sound effect control module 406 then adjusts a surrounding sound effect of the signal A₃ to obtain a signal A₄.

The power amplifier 408 then amplifies the signal A₄ to obtain a signal A₅. The output stage 410 then outputs a signal A₆ according to the signal A₅ as the output of the post-stage power amplifier 400. In one embodiment, the signal Aₗ is selected from the positive left channel signal, the negative left channel signal, the positive right channel signal, and the negative right channel signal output by the pre-stage audio processor. In another embodiment, the signal Aₗ is a left channel difference signal obtained by mixing the negative left channel signal with the positive left channel signal, or a right channel difference signal obtained by mixing the negative right channel signal with the positive right channel signal.

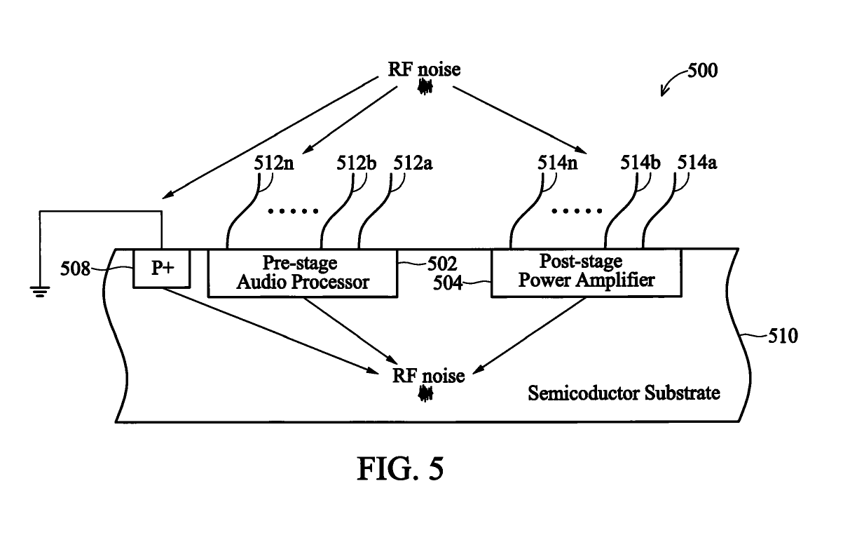

Referring to FIG. 5, a cross-sectional view of an integrated circuit 500 according to the invention is shown. In one embodiment, the integrated circuit 500 comprises a substrate 510, a pre-stage audio processor 502, a post-stage power amplifier 504, and a body terminal 508. The pre-stage audio processor 502, the post-stage power amplifier 504, and the body terminal 508 are all located on the substrate 510. The body terminal 508 couples ground contacts of the pre-stage audio processor 502 and the post-stage power amplifier 504 to a ground voltage source. A plurality of metal lines 512a˜512n are coupled to the pre-stage audio processor 502, and a plurality of metal lines 514a˜514n are coupled to the post-stage power amplifier 504. When the metal lines 512a˜412n and 514a˜514n transmit signals to the pre-stage audio processor 502 and the post-stage power amplifier 504, the metal lines 512a˜512n and 514a˜514n may be effected by radio frequency interferences, thus carrying radio frequency noises. Because the pre-stage audio processor 502 and the post-stage power amplifier 504 are coupled to the same ground voltage source, the pre-stage audio processor 502 and the post-stage power amplifier 504 have a common mode noise, which is further eliminated by the differential subtraction processing procedure of the post-stage power amplifier 504.

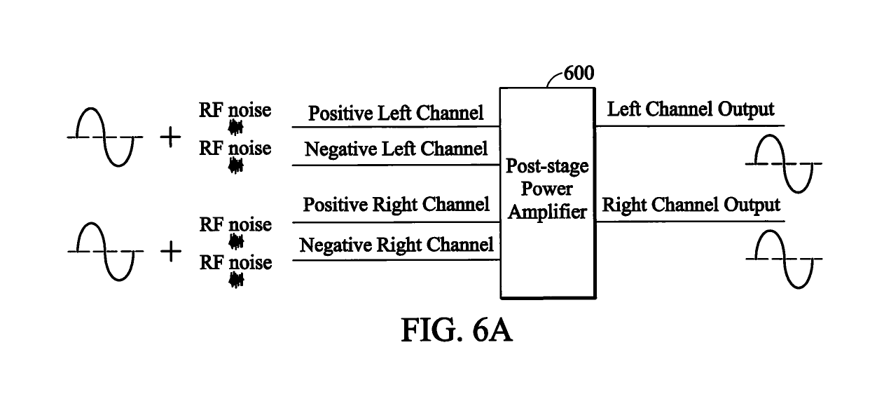

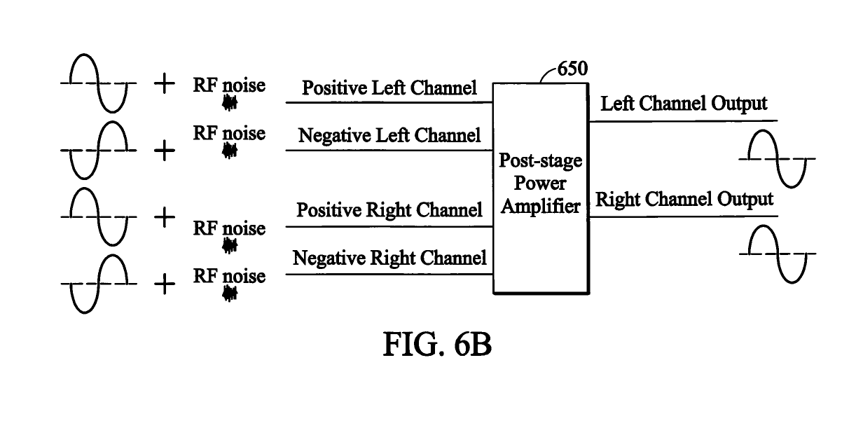

Referring to FIG. 6A, a schematic diagram of an embodiment of a post-stage power amplifier 600 eliminating a common mode noise according to the invention is shown. The post-stage power amplifier 600 receives a positive left channel signal, a negative left channel signal, a positive right channel signal, and a negative right channel signal. In one embodiment, the positive left channel signal carries an audio component and a common mode noise component, and the negative left channel signal carries only a common mode noise component. Thus, after the post-stage power amplifier 600 mixes the negative left channel signal with the positive left channel signal, the left channel output signal comprises only the audio component without the common mode noise component. Similarly, the positive right channel signal carries an audio component and a common mode noise component, and the negative right channel signal carries only a common mode noise component. Thus, after the post-stage power amplifier 600 mixes the negative right channel signal with the positive right channel signal, the right channel output signal comprises only the audio component without the common mode noise component. Thus, sound qualities of the left channel output signal and the right channel output signal are improved.

Referring to FIG. 6B, a schematic diagram of another embodiment of a post-stage power amplifier 650 eliminating a common mode noise according to the invention is shown. The post-stage power amplifier 650 receives a positive left channel signal, a negative left channel signal, a positive right channel signal, and a negative right channel signal. In one embodiment, the positive left channel signal carries a positive audio component and a common mode noise component, and the negative left channel signal carries a negative audio component and a common mode noise component. Thus, after the post-stage power amplifier 650 mixes the negative left channel signal with the positive left channel signal, the left channel output signal comprises no common mode noise component. Similarly, the positive right channel signal carries a positive audio component and a common mode noise component, and the negative right channel signal carries a negative audio component and a common mode noise component. Thus, after the post-stage power amplifier 650 mixes the negative right channel signal with the positive right channel signal, the right channel output signal comprises no common mode noise components. Thus, sound qualities of the left channel output signal and the right channel output signal are improved.

The invention provides an integrated circuit that is not influenced by noises due to radio frequency interferences. The integrated circuit has a smaller size, and can be installed on a portable electronic device. In addition, metal lines are encapsulated into the integrated circuit, thus simplifying circuit complexity and reducing layout area of the integrated circuit on a printed circuit board. No metal shells for shielding the radio frequency interferences are required, thus reducing manufacturing costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated circuit for reducing radio frequency interference due to antenna effects, comprising:
a pre-stage audio processor receiving a left channel input signal and a right channel input signal to process the left channel input signal to obtain a positive left channel signal and a negative left channel signal, and process the right channel input signal to obtain a positive right channel signal and a negative right channel signal; and
a post-stage power amplifier coupled to the pre-stage audio processor for amplifying the positive left channel signal and the negative left channel signal to obtain a left channel output signal, and amplifying the positive right channel signal and the negative right channel signal to obtain a right channel output signal.

2. The integrated circuit as claimed in claim 1, wherein pre-stage audio processor and the post-stage power amplifier are formed on the same substrate of the integrated circuit, wherein both the positive left channel signal and the negative left channel signal with a first common mode noise, and both the positive right channel signal and the negative right channel signal with a second common mode noise.

3. The integrated circuit as claimed in claim 2, wherein the post-stage power amplifier mixes the negative left channel signal with the positive left channel signal to obtain a left channel difference signal without the first common mode noise, and amplifies the left channel difference signal to obtain the left channel output signal.

4. The integrated circuit as claimed in claim 1, wherein the post-stage power amplifier mixes the negative right channel signal with the positive right channel signal to obtain a right channel difference signal without the second common mode noise, and amplifies the right channel difference signal to obtain the right channel output signal.

5. The integrated circuit as claimed in claim 1, wherein the substrate includes a body terminal for coupling the ground of the pre-stage audio processor and the post-stage power amplifier to a ground voltage level.

6. The integrated circuit as claimed in claim 1, wherein the pre-stage audio processor comprises:
an input channel selection module selecting a first signal from the left channel input signal and the right channel input signal;
an input gain control module coupled to the input channel selection module for adjusting a gain of the first signal to obtain a second signal;
a volume attenuation module coupled to the input gain control module for attenuating a volume of the second signal to obtain a third signal;
a loudness control module coupled to the volume attenuation module for adjusting a loudness of the third signal to obtain a fourth signal;
an automatic gain control module coupled to the loudness control module for automatically adjusting a gain of the fourth signal to obtain a fifth signal; and
an output gain control module coupled to the automatic gain control module for deriving a tenth signal from the fifth signal and a ninth signal.

7. The integrated circuit as claimed in claim 6, wherein the pre-stage audio processor further comprises:
a high pitch attenuation control module coupled to the automatic gain control module for adjusting an attenuation factor of a high-pitch component of the fifth signal to obtain a sixth signal;
a middle pitch attenuation control module coupled to the high pitch attenuation module for adjusting an attenuation factor of a middle-pitch component of the sixth signal to obtain a seventh signal;
a low pitch attenuation control module coupled to the middle pitch attenuation module for adjusting an attenuation factor of a low-pitch component of the seventh signal to obtain an eighth signal; and
a surrounding sound effect control module coupled to the low pitch attenuation control module for adjusting a surrounding sound effect of the eighth signal to obtain the ninth signal.

8. The integrated circuit as claimed in claim 6, wherein the positive left channel signal and the negative left channel signal are derived from the tenth signal when the first signal is the left channel input signal, and the positive right channel signal and the negative right channel signal are derived from the tenth signal when the first signal is the right channel input signal.

9. The integrated circuit as claimed in claim 1, wherein the post-stage power amplifier comprises:
a volume attenuation control module attenuating a volume of a first signal to obtain a second signal, wherein the first signal is selected from the positive left channel signal, the negative left channel signal, the positive right channel signal, and the negative right channel signal;
an amplification gain control module coupled to the volume attenuation control module for adjusting an amplification gain of the second signal to obtain a third signal;
a surrounding sound effect control module coupled to the amplification gain control module for adjusting a surrounding sound effect of the third signal to obtain the fourth signal;
a power amplifier coupled to the surrounding sound effect control module for amplifying the fourth signal to obtain a fifth signal; and
an output stage coupled to the power amplifier for outputting a sixth signal according to the fifth signal.

10. The integrated circuit as claimed in claim 1, wherein the integrated circuit reduces interferences caused by antenna effects of the pre-stage audio processor and the post-stage power amplifier.

11. An integrated circuit for reduced radio frequency interference due to antenna effects, comprising:
a substrate;
a pre-stage audio processor located on the substrate for receiving an input signal and performing a first signal processing procedure on the input signal to obtain a positive signal and a negative signal; and
a post-stage power amplifier located on the substrate, which is coupled to the pre-stage audio processor and performing a second signal processing procedure on the positive signal and the negative signal to obtain an output signal; and
a body terminal located on the substrate for coupling the ground of the pre-stage audio processor and the post-stage power amplifier to a ground voltage level.

12. The integrated circuit as claimed in claim 11, wherein both the positive signal and the negative signal with a common mode noise due to coupling of the ground of the pre-stage audio processor and the post-stage power amplifier to the ground voltage level.

13. The integrated circuit as claimed in claim 12, wherein the post-stage power amplifier mixes the negative signal and the positive signal to obtain a difference signal without the common mode noise, and amplifies the difference signal to obtain the output signal.

14. The integrated circuit as claimed in claim 11, wherein the first signal processing procedure is an audio processing procedure and the second signal processing procedure is a power amplification procedure.

15. The integrated circuit as claimed in claim 11, wherein the pre-stage audio processor comprises:
an input channel selection module receiving the input signal as a first signal;
an input gain control module coupled to the input channel selection module for adjusting a gain of the first signal to obtain a second signal;
a volume attenuation module coupled to the input gain control module for attenuating a volume of the second signal to obtain a third signal;
a loudness control module coupled to the volume attenuation module for adjusting a loudness of the third signal to obtain a fourth signal;
an automatic gain control module coupled to the loudness control module for automatically adjusting a gain of the fourth signal to obtain a fifth signal; and
an output gain control module coupled to the automatic gain control module for deriving a tenth signal from the fifth signal and a ninth signal.

16. The integrated circuit as claimed in claim 15, wherein the pre-stage audio processor further comprises:
a high pitch attenuation control module coupled to the automatic gain control module for adjusting an attenuation factor of a high-pitch component of the fifth signal to obtain a sixth signal;
a middle pitch attenuation control module coupled to the high pitch attenuation module for adjusting an attenuation factor of a middle-pitch component of the sixth signal to obtain a seventh signal;
a low pitch attenuation control module coupled to the middle pitch attenuation module for adjusting an attenuation factor of a low-pitch component of the seventh signal to obtain an eighth signal; and
a surrounding sound effect control module coupled to the low pitch attenuation control module for adjusting a surrounding sound effect of the eighth signal to obtain the ninth signal.

17. The integrated circuit as claimed in claim 16, wherein the positive signal and the negative signal are derived from the tenth signal.

18. The integrated circuit as claimed in claim 11, wherein the post-stage power amplifier comprises:
a volume attenuation control module attenuating a volume of a first signal to obtain a second signal, wherein the first signal is selected from the positive signal and the negative signal;
an amplification gain control module coupled to the volume attenuation control module for adjusting an amplification gain of the second signal to obtain a third signal;
a surrounding sound effect control module coupled to the amplification gain control module for adjusting a surrounding sound effect of the third signal to obtain the fourth signal;
a power amplifier coupled to the surrounding sound effect control module, for amplifying the fourth signal to obtain a fifth signal; and
an output stage coupled to the power amplifier for outputting a sixth signal according to the fifth signal.

19. The integrated circuit as claimed in claim 11, wherein the integrated circuit reduces interferences caused by antenna effects of the pre-stage audio processor and the post-stage power amplifier.
